(19) United States
(12) Patent Application Publication
(10) Pub. No.: US 2009/0114771 A1
(43) Pub. Date: May 7, 2009

(54) Split Return Wing

(76) Inventor: Qian Mu, Yantai (CN)

Correspondence Address: GLOBAL IP SERVICES, 7285 W. Eagle Court, Winton, CA, 95388, US

(21) Appl. No.: 12/033,513

(22) Filed: Feb. 19, 2008

(30) Foreign Application Priority Data
Nov. 5, 2007 (CN) 200720029535.7

(51) Int. Cl. B64C 3/00

(52) U.S. Cl. 244/123.1

(57) ABSTRACT

The present invention concerns a sort of split return wing. The split return wing contains main wing body, which connects with the fuselage main support frame, and the tilting-able segments of main wing-spar are installed on the fuselage main support frame actively. Two ends of the tilting-able segments of main wing-spar connect with the fixed segments of main wing-spar actively. Two split return wing sector wing-pieces are installed on the right and the left tilting-able segment of main wing-spar separately. There is one group tilting-able dynamic device in front of every split return sector wing-piece. The split return sector wing-pieces can be in the perforation spaces of the main wing body, and their shapes are same. And two big wingspan outer-wings are set on the right and left of the main wing body separately. The Split return wing will decrease unbalanced moment of aircraft to the minimum when the aircraft is taking off & landing vertically. They also will decrease the air resistance of the whole wing to the minimum when the aircraft flies transitionally. At the same time, the whole wing, especially the big wingspan outer-wings still keep horizontally from beginning to end. In this case, it will ensure that the aircraft is taking off & landing vertically, and will fly transitionally toward horizontal high-speed flight smoothly, so, the wing could satisfy the demand of persons.

### CROSS REFERENCE TO RELATED PATENT APPLICATION

This application claims the priority of the Chinese patent application No. 200720029535.7 with filing date of Nov. 5, 2007, the content of which is incorporated herein by reference thereto.

### FIELD OF THE INVENTION

The present invention concerns a sort of plane wing, further concerns a split return wing.

### BACKGROUND OF THE INVENTION

Nowadays, varies aircrafts, which respectively use propellers or contra-rotating propellers or ducted fans, taking off & landing vertically. Propellers, or contra-rotating propellers or ducted fans are usually installed on the ends of wing, or tilted with the whole wing as to form tilting-able dynamic force for aircraft, that unbalanced moment is great when the aircrafts are taking off & landing vertically. In this case, the aircrafts will lose the balance to roll athwartships, or the air resistance of the whole wing will be great that the aircrafts hardly fly transitionally. The above situation is one of the main reasons, that there are few aircrafts successful. So, these structures of wing could not satisfy the demand of persons, with which the aircrafts are taking off & landing vertically.

### SUMMARY OF THE INVENTION

The purpose of the present invention is to provide a sort of split return wing. It will decrease unbalanced moment of aircraft to the minimum when the aircraft is taking off & landing vertically; it also will decrease the air resistance of the whole wing to the minimum when the aircraft flies transitionally. At the same time, the whole wing, especially the big wingspan outer-wings still keep horizontally from beginning to end. In this case, it will ensure stability when the aircraft is taking off & landing vertically, and will fly transitionally toward horizontal high-speed flight smoothly, so, the wing could satisfy the demand of persons.

The purpose of the present invention could be realized through the following technical programs. The Split return wing contains main wing body, which connects with the fuselage main support frame. And the tilting-able segments of main wing-spar are installed on the fuselage main support frame actively. Two ends of the tilting-able segments of main wing-spar connect with the fixed segments of main wing-spar actively. Two split return sector wing-pieces are installed on the right and the left tilting-able segment of main wing-spar separately. There is one group tilting-able dynamic device in front of every split return sector wing-piece. The split return sector wing-pieces can be in the perforation spaces of the main wing body, their shapes are same. And two big wingspan outer-wings are set on the right and the left of the main wing body separately.

In order to further realize the purpose of the present invention, we also use the following technical programs: the tilting-able segments of main wing-spar contain the tilted rocker arm connecting with the left tilting-able segment of main wing-spar and the right tilting-able segment of main wing-spar, the structures of the left and the right tilting-able segment of main wing-spar are symmetrical. Among others, the right tilting-able segment of main wing-spar includes the hollow part, the solid part and the frame for installing the tilting-able dynamic device. The split return sector wing-piece is fixed behind of the hollow part, the solid part and the frame.

Driver shaft, whose one end is connected to the tilting-able dynamic device, another end inserts the aircraft body, through the hollow part. There are the right big wingspan outer-wing and the left big wingspan outer-wing set on two ends of the main wing body. There are two perforation spaces in the right and left of main wing body separately, the right split return sector wing-piece and the left split return sector wing-piece can be in the perforation spaces of the main wing body separately. The frame, which is also the support part of the tilting-able segment of main wing-spar, is for installing the tilting-able dynamic device. The frame could support the aerodynamic force of tilting-able dynamic device and the lift force of the wing. The tilting-able dynamic device can be propeller, or contra-rotating propeller, or ducted fan, etc, and its reduction device also will be installed on the frame. The flaps are installed on back of the right and left main wing body separately; the aileron & flaps are installed on back of the right big wingspan outer-wing and the left big wingspan outer-wing separately.

The positive effects of the present invention are: the wing has the split return sector wing-pieces, and the split return sector wing-pieces could tilt with the tilting-able dynamic devices. The split return sector wing-pieces split downward from the main wing body when the aircraft is taking off & landing vertically, so that the axes of the tilting-able dynamic devices are all perpendicular to the earth. In this case, the aircraft could obtain the lift force, that realize the aircraft taking off & landing vertically, hovering in the air, flying forward, flying backward and so on. At this time, the whole wing, especially the big wingspan outer-wings still keep horizontally; when the aircraft begins to fly horizontally, the split return sector wing-pieces tilt upward with the tilting-able dynamic devices, so they return to the main wing body again to form the complete wing, then the tilting-able dynamic devices could jet backward that they become thrusters completely. So, the tilting-able dynamic devices thrust the aircraft flying horizontally in high speed, that it could solute the existing technical problems.

The present invention has the following unique and outstanding advantages: 1. The left tilting-able dynamic device and the right tilting-able dynamic device are set both sides of the aircraft's axis as close as possible, that it ensures their outer atmosphere field are same. The unbalance-disturbed moment is eliminated, it ensures the horizontal stability when the aircraft is taking off & landing vertically, it also ensures the direct stability when the aircraft flies horizontally in high speed; 2. The split return sector wing-pieces split downward from the main wing body when the aircraft is taking off & landing vertically, which ensures that the tilting-able dynamic devices could jet downward completely, so the aircraft could obtain the maximum lift force; 3. The size of wing is not restricted, especially the big wingspan outer-wings, which have the high lift drag ratio, are fundamental guarantee for stability, safety, economy and other important flying qualities of the aircraft; 4. The dynamic jet flow of the tilting-able dynamic devices have small effect on the flow field of wing, the whole wing, especially the big wingspan outer-wings still keep horizontally in the smooth laminar flow from beginning to end, so, the aircraft could obtain very stable lift force, it is extraordinarily important for the aircraft flying transitionally; 5. Compare to the aircraft, which tilts the whole wing, the split return sector wing-pieces let the air-resistance area decrease to minimum. The split return sector wing-pieces are also in the high-speed jet flow of the tilting-able dynamic devices, so that the speed of jet flow on their surface is far greater than the air-resistance flow. The highest speed of transitional flying is about 120 kilometers/hour, so the air-resistance can be neglected; 6. The active line of the lift force is just through the aircraft's center of gravity. The aircraft's center of gravity, the center of the wing's aerodynamic force and the focus of the aircraft can be the best match. So, the aircraft could get overall balance; 7. The speed of jet flow is very high, at the same time the bottom jet flow could be isolated by the main wing, so they hardly flow above the edge of the propeller plate again, in this case, dangerous vortex ring never turn up; 8. The power transmission path is short, structure is simple, weight is light, and the transmission efficiency is high. The structure of the split return sector wing-pieces could be match two flight states mostly: which are the aircraft taking off & landing vertically and flying horizontally in high speed. The big wingspan, which has high lift drag ratio, is the foundation stone of the aircraft flying in subsonic speed.

### BRIEF DESCRIPTION OF THE DRAWINGS

FIG. 1 is a schematic diagram of structure of the present invention; In FIG. 1, the split return sector wing-pieces split downward from the main wing body;

FIG. 2 is a schematic diagram of structure of the present invention. In FIG. 2, the split return sector wing-pieces return to the main wing body again.

In the drawings: 1—the perforation space, 2—propeller, 3—the skin of the aircraft, 4—the tilted active rod for the tilting-able segment of main wing-spar, 5—the first seal ring, 6—the driver shaft, 7—the hollow part of the tilting-able segment of main wing-spar, 8—the solid part of the tilting-able segment of main wing-spar, 9—the second seal ring, 10—the support joint of the fixed segment of main wing-spar, 11—the right big wingspan outer-wing, 12—the fixed segment of main wing-spar, 13—the aileron & flap, 14—the aft wing-spar, 15—the fuselage main support frame, 16—the main wing body, 17—the flap, 18—the fairing of the propeller hub, 19—the tilted rocker arm for the tilting-able segment of main wing-spar, 20—the split return sector wing-piece, 21—the frame for installing tilting-able dynamic device, 22—the left big wingspan outer-wing.

### DETAILED DESCRIPTION OF THE INVENTION

The present invention is the split return wing, which contains the main wing body 16, the main wing body 16 connects with the fuselage main support frame 15, the tilting-able segments of main wing-spar are installed on the fuselage main support frame 15 actively. Two ends of the tilting-able segments of main wing-spar connect with the fixed segments of main wing-spar actively. Two split return sector wing-pieces are installed on the right and the left tilting-able segment of main wing-spar separately. There is one group tilting-able dynamic device in front of every split return sector wing-piece. The split return sector wing-pieces can be in the perforation spaces in the main wing body, their shapes are same. And two big wingspan outer-wings are set on the right and left of the main wing body separately. When the aircraft is taking off & landing vertically, two tilting-able dynamic devices are tilted upward by tilting-able segments of main wing-spar, at the same time, the split return sector wing-pieces split downward from the main wing body, until perpendicular to the main wing body, but the whole wing, especially the big wingspan outer-wings still keep horizontally from beginning to end; when the aircraft flies in cruising speed, tilting-able segments of main wing-spar are tilted gradually, so two tilting-able dynamic devices are tilted forward also. At the same time, the split return sector wing-pieces return to the main wing body again, the aircraft begins cruising fly horizontally. The time between the vertical state and the horizontal state is about 20-30 seconds.

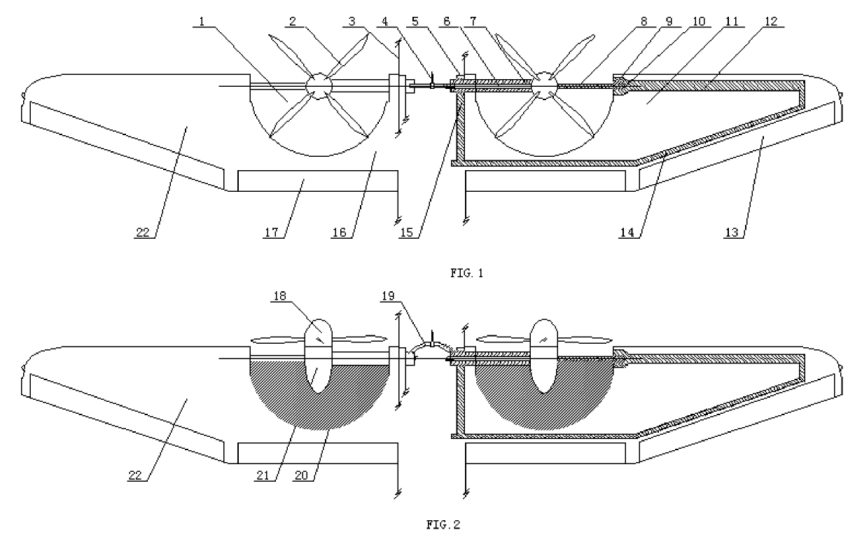

In FIG. 1, the tilted rocker arm 19 connecting with the left tilting-able segment of main wing-spar and the right tilting-able segment of main wing-spar, the structures of the left and the right tilting-able segment of main wing-spar are symmetrical. Among others, the right tilting-able segment of main wing-spar includes the hollow part 7, solid part 8 and the frame for installing tilting-able dynamic device 21. The split return sector wing-piece is fixed behind of the hollow part, the solid part and the frame.

The driver shaft 6, which through the hollow part 7, has two functions: first, the power of engine could be transmitted to the tilting-able dynamic device from the fuselage by the driver shaft 6; second, the driver shaft 6 connects with another side tilting-able dynamic device, to make the left and the right power balance. The driver can control the tilted rocker arm for the tilting-able segment of main wing-spar 19 through the manual lever or the hydraulic power device in the aircraft.

In order to control the aircraft normally when it flies horizontally, the flaps are installed on back of the right and left main wing body 16, and the aileron& flaps are installed on back of the left big wingspan outer-wing and the right big wingspan outer-wing separately.

We can produce and assemble hardware in accordance with above requirements when we produce the present invention. The technical programs of the present invention are not only used in the scope of light aircrafts but also used in carrying aircraft, carrier aircraft, unmanned aircraft, etc, which all are taking off & landing vertically. The technical contents, which are not described, are well known to the public.

What is claimed is:

1. A split return wing comprising:
a main wing body connecting with a fuselage main support frame;
tilting-able segments of main wing-spar being installed on the fuselage main support frame actively, two ends of the tilting-able segments of main wing-spar connecting with fixed segments of main wing-spar actively;
two split return sector wing-pieces being installed on the right and left tilting-able segments of main wing-spar separately, a group tilting-able dynamic device being fixed in front of each split return sector wing-piece;
the split return sector wing-pieces being located in perforation spaces of the main wing body with same shapes of the perforation spaces; and
two big wingspan outer-wings being set on the right and left of the main wing body separately.

2. The split return wing of claim 1, wherein a tilted rocker arm connects with the left and right tilting-able segments of main wing-spar, the structures of the left and the right tilting-able segments of main wing-spar are symmetrical, the right tilting-able segment of main wing-spar includes a hollow part, solid part, and a frame for installing the tilting-able dynamic device, the split return sector wing-piece is fixed behind of the hollow part, the solid part and the frame.

3. The split return wing of claim 2, wherein a driver shaft, whose one end is connected to the tilting-able dynamic device, another end inserts into an aircraft body, through the hollow part.

4. The split return wing of claim 1, wherein the main wing body has the right big wingspan outer-wing and the left big wingspan outer-wing, the two perforation spaces are in the right and the left of the main wing body separately, the right split return sector wing-piece and the left split return sector wing-piece are located in the perforation spaces of the main wing body separately.

5. The split return wing of claim 4, wherein the frame is a support part of the tilting-able segment of main wing-spar for installing the tilting-able dynamic device, the frame could support the aerodynamic force of tilting-able dynamic device and the lift force of the wing, the tilting-able dynamic device can be propeller, or contra-rotating propeller, or ducted fan, and its reduction device also will be installed on the frame.

6. The split return wing of claim 5, wherein flaps are installed on back of the right and left main wing body, and aileron & flaps are installed on back of the right big wingspan outer-wing and the left big wingspan outer-wing separately.

7. The split return wing of claim 2, wherein the main wing body has the right big wingspan outer-wing and the left big wingspan outer-wing, the two perforation spaces are in the right and the left of the main wing body separately, the right split return sector wing-piece and the left split return sector wing-piece are located in the perforation spaces of the main wing body separately.

8. The split return wing of claim 3, wherein the main wing body has the right big wingspan outer-wing and the left big wingspan outer-wing, the two perforation spaces are in the right and the left of the main wing body separately, the right split return sector wing-piece and the left split return sector wing-piece are located in the perforation spaces of the main wing body separately.
